(19) United States
(12) Patent Application Publication
(10) Pub. No.: US 2011/0285890 A1
(43) Pub. Date: Nov. 24, 2011

(54) CAMERA MODULE

(75) Inventors: Mi-Na Choi, Seoul (KR); Kyoung-Sei Choi, Yongin-si (KR); Se-Ran Bae, Yongin-si (KR)

(73) Assignee: SAMSUNG ELECTRONICS CO., LTD., Suwon-si (KR)

(21) Appl. No.: 13/074,056

(22) Filed: Mar. 29, 2011

(30) Foreign Application Priority Data
May 20, 2010 (KR) 10-2010-0047425

(51) Int. Cl. H04N 5/335; H04N 5/225

(52) U.S. Cl. 348/308; 348/374; 348/E05.091; 348/E05.024

(57) ABSTRACT

A camera module has a lens unit including a lens, a first chip having an image region on which an image is formed from light having passed through the lens unit, a housing enclosing side surfaces of the lens unit and the first chip, a second chip and at least one printed circuit board. The chips are mounted to the at least one printed circuit board.

### PRIORITY STATEMENT

This application claims priority from Korean Patent Application No. 10-2010-0047425 filed on May 20, 2010 in the Korean Intellectual Property Office, and all the benefits accruing therefrom under 35 U.S.C. 119.

### BACKGROUND

The inventive concept relates to cameras that capture images digitally. In particular, the inventive concept relates to a module of such cameras which includes a lens unit and a chip or chipset.

Recently, communications over the Internet via mobile devices have come to frequently include the transfer of digital images. In particular, next-generation mobile communications include an ability to transfer images including video. Thus, there is a great demand for subminiature camera modules that provide the backbone of high performance and multifunctional digital cameras.

In particular, today's mobile phones each have a camera that includes a small camera module made up of a lens unit integrated with a chip or chipset. The most important factor in the development of these camera modules is miniaturization because the size of the mobile phone is dependent on the size of its camera module.

### SUMMARY

According to one aspect of the inventive concept there is provided a camera module having a lens unit including a lens, a first chip integral with the lens unit and having an image region disposed along an optical axis of the module such that light having passed through the lens unit is incident on the image region, a housing extending around the lens unit and the first chip so as to enclose side surfaces of the lens unit and the first chip, and a second chip seated in a recess in a sidewall of the housing.

According to another aspect of the inventive concept, there is provided a camera module having a lens unit including a lens, a first chip integral with the lens unit and having an image region disposed along an optical axis of the module such that light having passed through the lens unit is incident on the image region, a printed circuit board to which the first chip is mounted, and a film package attached to the printed circuit board. The film package includes a film having a circuit on a surface thereof, and a second chip mounted to the film.

According to another aspect of the inventive concept, there is provided a camera module having a housing, a lens unit disposed within the housing and including a lens, a first chip disposed within the housing and integral with the lens unit, a second chip, and at least one printed circuit board. The first chip has an image region disposed along an optical axis of the module such that light having passed through the lens unit is incident on the image region. The first and second chips are mounted and electrically connected to the at least one circuit board. The at least one printed circuit board may include or consist of a first printed circuit board through which the first and second chips are physically connected and to which the housing is secured. At least a portion of the first circuit board is flexible, meaning that the portion may be bent without breaking and retain its bent shape. At least part of the flexible portion is interposed between and physically separates the second chip from the first chip.

### BRIEF DESCRIPTION OF THE DRAWINGS

The above and other aspects and features of the inventive concept will become more apparent from the detailed description of preferred embodiments thereof that follows, made with reference to the attached drawings in which:

FIG. 1 is a cross-sectional view of an example of a first embodiment of a camera module in accordance with the inventive concept;

FIGS. 2 to 4 are each a cross-sectional views of another respective example of the first embodiment of a camera module in accordance with the inventive concept;

FIG. 5 is a cross-sectional view of an example of a second embodiment of a camera module in accordance with the inventive concept;

FIGS. 6 to 9 are each a cross-sectional view of another respective example of the second embodiment of a camera module in accordance with the inventive concept;

FIG. 10 is a cross-sectional view of a structure including the camera module shown in FIG. 5 and a case in which the camera module is inserted;

FIGS. 11A to 11C are each a cross-sectional view and together illustrate a method of manufacturing the camera module shown in FIG. 1 in accordance with the inventive concept; and

FIGS. 12A to 12C are each a cross-sectional view and together illustrate a method of manufacturing the camera module shown in FIG. 3 in accordance with the inventive concept.

### DETAILED DESCRIPTION OF THE PREFERRED EMBODIMENTS

Various embodiments and examples of embodiments of the inventive concept will be described more fully hereinafter with reference to the accompanying drawings. In the drawings, the sizes and relative sizes and shapes of elements shown in section may be exaggerated for clarity. Also, when like numerals appear in the drawings, such numerals are used to designate like elements.

It will also be understood that when an element is referred to as being “on” or “connected to” another element or layer, it can be directly on or directly connected to the other element or intervening elements may be present. In contrast, when an element or layer is referred to as being “directly on” or “directly connected to” another element or layer, there are no intervening elements or layers present. In any case, the drawings accurately depict whether one element is directly or indirectly disposed on another, but the drawings are not necessarily limiting in this respect.

It will be understood that although the terms first, second, etc. are used herein to describe various elements, these elements are not limited by these terms. These terms are only used to distinguish one element from another.

Other terminology used herein for the purpose of describing particular examples or embodiments of the inventive concept is to be taken in context. For example, the terms “comprises” or “comprising” specifies the presence of stated features but does not preclude the presence or additional features.

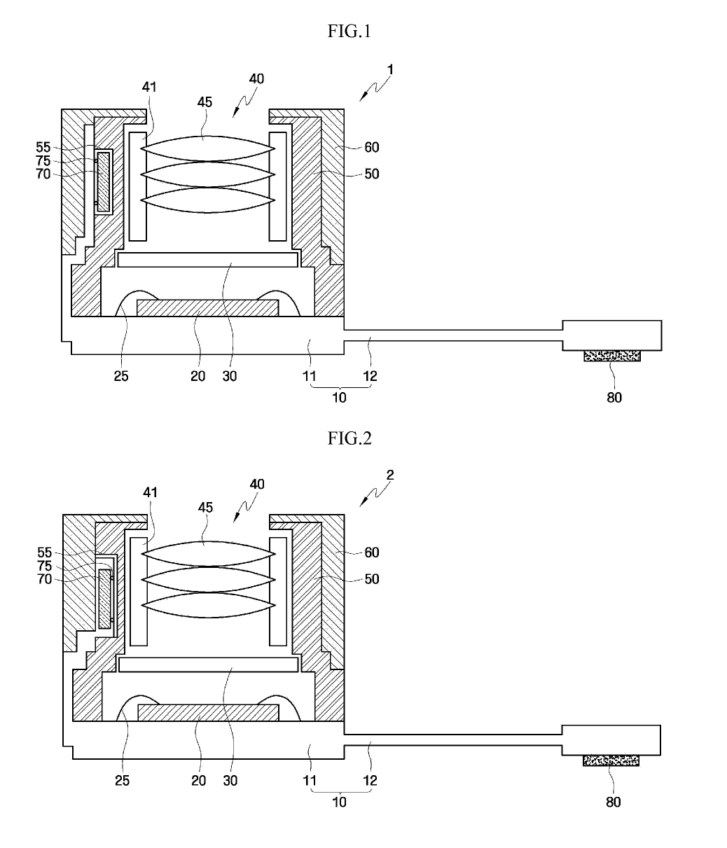

A first embodiment of a camera module in accordance with the inventive concept will now be described with reference to FIG. 1.

The camera module 1 includes a lens unit 40, a first chip 20 on which light having passed through the lens unit 40 is incident to form an image, a housing 50 surrounding the first chip 20 and the lens unit 40, a second chip 70 seated in the housing 50, a printed circuit board (PCB) 10 to which the first chip 20 and the second chip 70 are electrically connected, a metal cover 60 covering the housing 50, and a connector 80.

The lens unit 40 includes one or more lenses 45 and a lens barrel 41 supporting the lenses 45. Note, the structure of the lens unit 40 is simplified in the drawings for ease of illustration. Each lens 45 is formed of a transparent material such as glass or plastic, may be a spherical or aspherical lens, and may converge or diverge incident light to form an optical image. In the case of using plastic, the lenses may be mass-produced using injection molding at a low cost per unit. On the other hand, glass lenses offer high resolution. In any case, the number of lenses of the lens unit 40, their shape or type, and the material from which they are manufactured are selected according to the specifications of the camera module, i.e., according to desired characteristics of the camera which is to employ the camera module.

The first chip 20 has an image region which receives light having passed through the lens unit 40, and converts the light into an electric signal representative of the image formed by the light. The first chip 20 may comprise a complementary metal oxide semiconductor (CMOS) image sensor or a charge coupled device (CCD) image sensor. A CCD image sensor is an analog device having a plurality of cells to which light incident on the lenses 45 is distributed. The respective cells store electric charges corresponding to the energy of the incident light, brightness is determined based on the magnitude of the electric charges and the charges are transmitted to a converter to form data representative of the colors of the image. A CCD image sensor chip can provide a clear high-quality image, but requires high data storage capacity and consumes a relatively large amount of power. Accordingly, CCD image sensor chips are widely used in digital cameras required to produce high quality images. A CMOS image sensor chip includes integrated analog and digital signal processing circuits. The power consumption of a CMOS image sensor chip is only one tenth of the power consumption of a CCD image sensor chip. A CMOS image sensor chip is compact and thus, is widely used in digital cameras, camera phones, personal media players (PMP) and the like.

An infrared cut filter (IR cut filter) 30 may be positioned in the optical path of the module extending between the lens unit 40 and the image region of the first chip 20. The range of wavelengths of visible light (the visible spectrum) is 400 nm to 700 nm, and the image sensor can detect light having a wavelength in a range of 380 nm to 1,000 nm. Accordingly, the image sensor is more sensitive to infrared light than the human eye. Accordingly, the IR cut filter 30 filters out infrared light before the image is transmitted to the image sensor, thereby enhancing color reproducibility.

The housing 50 encloses the side surfaces of the lens unit 40 and the first chip 20. The housing 50 may be formed of epoxy, an alkyd, or silicone resin or the like and thus, may be manufactured by injection molding. The top of the housing 50 is open to allow for the introduction of light to the lens unit 40. Furthermore, a recess 55 is formed in the outer circumferential surface of a sidewall of the housing 50 and the second chip 70 is seated in the recess 55. The recess 55 may be formed as part of the injection molding process used to fabricate the housing 50.

The second chip 70 may include an image sensor processor, an autofocus actuator driver integrated circuit (IC), a passive device, or a memory or the like. An image sensor processor is for processing signals produced by and transmitted from the first chip 20 in the case in which the first chip consists of an image sensor. An autofocus actuator driver integrated circuit (IC) is for controlling the optics of the camera to focus on a point or region based on feedback. A passive device refers to an electronic component such as a resistor, an inductor, or a capacitor.

In this example, the first chip 20 and the second chip 70 are mounted to the printed circuit board 10. The printed circuit board 10 may include an insulating substrate having one surface on which a circuit pattern (wiring) is formed of copper or the like. The substrate may be a laminate, i.e., may have multiple layers on which wiring is formed. The printed circuit board 10 may also be a rigid flexible printed circuit board (rigid FPCB). Hereinafter, an example of the present embodiment in which the printed circuit board 10 is a rigid flexible printed circuit board will be described, but the inventive concept is not so limited.

The rigid flexible printed circuit board 10 includes a relatively rigid section 11 (referred to as a rigid region hereinafter) and a relatively flexible section 12 (referred to as a flexible region hereinafter). The rigid region 11 and the flexible region 12 are distinguished from each other by a significant relative difference in their flexibilities rather than an absolute flexibility or lack of flexibility. To this end, the substrate of the rigid flexible printed circuit board 10 may have a greater number of layers in the rigid region 11 than in the flexible region 12. In any case, the flexible region 12 allows the rigid flexible printed circuit board 10 to be bent (thereat) when, for example, the rigid flexible printed circuit board 10 is inserted into a part or the like. Furthermore, each of the rigid and flexible sections may have discontinuous, i.e., non-contiguous, portions. For example, as shown in the figure, one portion of the rigid region 11 forms one end of the rigid flexible printed circuit board 10 (where the connector 80 is mounted), one portion of the flexible region 12 forms the other end of the rigid flexible printed circuit board 10 (where the second chip 70 is mounted), another portion of the rigid region 11 forms a central part of the rigid flexible printed circuit board 10 (faced by the first chip 20), and another portion of the flexible region 12 also forms a central part of the rigid flexible printed circuit board 10 (and connects the aforementioned portions of the rigid region 12 to one another).

The first chip 20 is mounted on the rigid region 11 of the rigid flexible printed circuit board 10, and the second chip 70 is mounted on the flexible region 12 of the rigid flexible printed circuit board 10. In this respect, the first chip 20 can be mounted to the rigid flexible printed circuit board 10 using a through-silicon via or a wire bonding method in which wires 25 are bonded to the circuit pattern. The second chip 70 can be mounted to the rigid flexible printed circuit board 10 by a flip-chip bonding method using solder balls or metal bumps 75 or the like.

That part of the rigid region 11 of the rigid flexible printed circuit board 10 to which the first chip 20 is mounted is arranged below the housing 50. The flexible region 12 of the rigid flexible printed circuit board 10 to which the second chip 70 is mounted is bent upward from the rigid region 11 beneath the housing 50 and extends along the sidewall of the housing 50, so that the second chip 70 can be seated in the recess 55 of the housing 50. The disposition of the second chip 70 in the recess 55 in the sidewall of the housing 50 allows for a compact camera module 1.

The connector 80 for applying an external signal to the camera module 1 is attached to one end of the rigid flexible printed circuit board 10. In this example, the connector 80 is attached to the rigid region 11 where it is electrically connected to the circuit pattern of the rigid flexible printed circuit board 10. Thus, the connector 80 is electrically connected to the first and second chips 20 and 70 through the wiring of the rigid flexible printed circuit board 10 so that signals can be transmitted to and from the first and second chips 20 and 70 via the electrical connector 80.

The metal cover 60 surrounds the sidewall of the housing 50. The metal cover 60 may be used to shield the chip 20 from external electromagnetic waves. The metal cover 60 also secures the flexible region 12 of the rigid flexible printed circuit board 10, to which the second chip 70 is mounted, to the housing 50 to fix the second chip 70 within the recess 55.

Another example of a camera module in accordance with the inventive concept will be described with reference to FIG. 2.

In the camera module 2 of this example, the second chip 70 is embedded in the flexible region 12 of the rigid flexible printed circuit board 10. In this case, the second chip 70 is electrically connected to (the printed circuitry of) the rigid flexible printed circuit board 10 by a flip-chip bonding method using solder balls or metal bumps 75 or the like. Otherwise, this embodiment of the camera module 2 is similar to the embodiment of FIG. 1. In particular, that part of the rigid flexible printed circuit board 10 in which the second chip 70 is embedded is received in the recess 55 of the housing 50, so that the second chip 70 is seated in the recess 55.

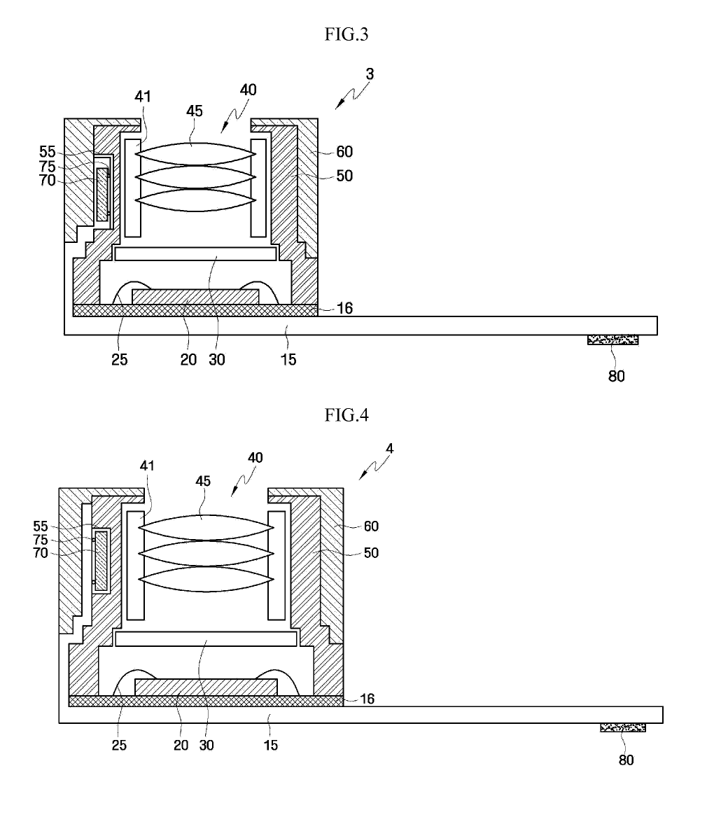

Another example of a camera module in accordance with the inventive concept will now be described with reference to FIG. 3.

In the camera module 3 of this example, the first chip 20 is mounted to a first printed circuit board 16 and the second chip 70 is embedded in a second printed circuit board 15. The second printed circuit board 15 is a flexible printed circuit board (FPCB). The first printed circuit board 16 is attached and electrically connected to the second printed circuit board 15. Otherwise, this embodiment of the camera module 3 is similar to the embodiment of FIG. 2.

Another example of a camera module in accordance with the inventive concept will now be described with reference to FIG. 4.

In the camera module 4 of this example, the first chip 20 is mounted to a first printed circuit board 16, the second chip 70 is surface-mounted to a second printed circuit board 15, and the second printed circuit board 15 may be a flexible printed circuit board (FPCB). Also, similar to the camera module 3, the first printed circuit board 16 is attached and electrically connected to the second printed circuit board 15. Otherwise, this embodiment of the camera module 3 is similar to the embodiment of FIG. 1.

FIG. 5 shows another embodiment of a camera module in accordance with the inventive concept.

This camera module 5 includes a circuit film 91 (a film on which an electric circuitry is printed) to which the second chip 70 is mounted and electrically connected to form a film package 90. The film package 90 is attached and electrically connected to the rigid flexible printed circuit board 10.

The second chip 70 may be mounted to the circuit film 91 by a flip-chip bonding method using solder balls or metal bumps 75 or the like. The film package 90 may also be attached to the rigid flexible printed circuit board 10 by adhesive 95. The adhesive 95 may be an anisotropic conductive film in which case the adhesive both attaches the film package to the circuit board 10 and electrically connects the circuit film and hence, the second chip 70, to the circuit board 10.

The film package 90 may be attached to the flexible region 12 of the rigid flexible printed circuit board 10. In this example, the film package 90 is attached to a surface (side) of the rigid flexible printed circuit board 10 opposite that on which the first chip 20 is mounted.

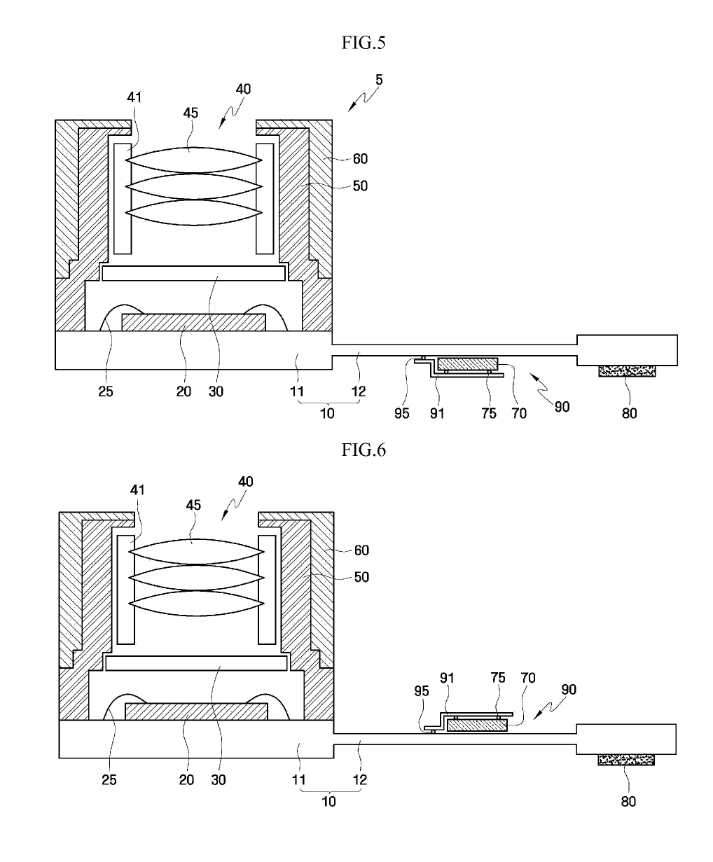

Other examples of the second embodiment of the camera module according to the inventive concept will now be described with reference to FIGS. 6 to 9.

Referring to FIG. 6, the film package 90 including the second chip 70 is attached to the same surface (side) of the rigid flexible printed circuit board 10 as the first chip 20. Otherwise, the camera module is similar to that described above with reference to FIG. 5.

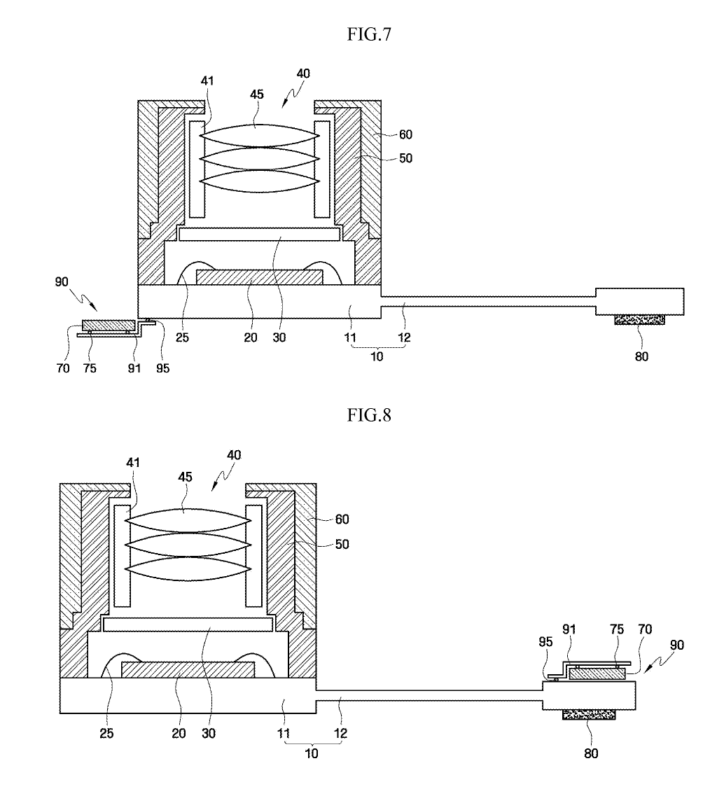

Referring to FIG. 7, in the camera module of this example, the film package 90 including the second chip 70 is attached to the rigid region 11 of the rigid flexible printed circuit board 10. Also, in this example, the film package 90 is attached to a surface (side) of the rigid flexible printed circuit board 10 opposite that on which the first chip 20 is mounted. Otherwise, the camera module is similar to those examples of the second embodiment described above.

Referring to FIG. 8, in the camera module of this example, the film package 90 including the second chip 70 is attached above the connector 80 to the rigid region 11 of the rigid flexible printed circuit board 10. Otherwise, the camera module is similar to those examples of the second embodiment described above.

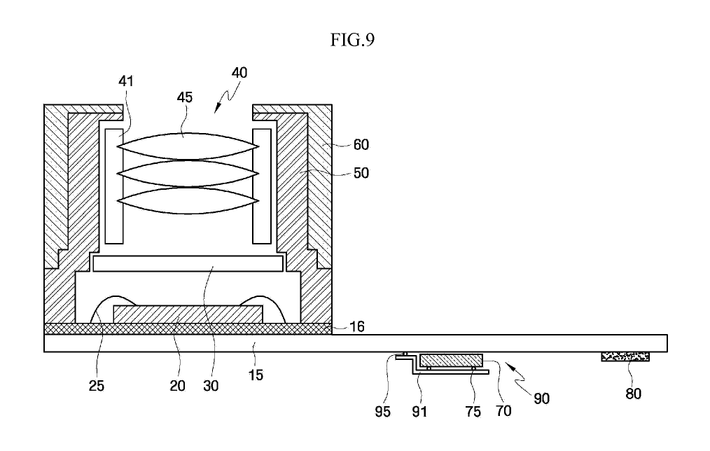

Referring to FIG. 9, in the camera module of this example, the first chip 20 is mounted to a first printed circuit board 16, and the film package 90 including the second chip 70 is attached to a second printed circuit board 15. Similarly to the examples of the first embodiment shown in and described above with reference to FIGS. 3 and 4, the second printed circuit board 15 is a flexible printed circuit board (FPCB), and the first printed circuit board 16 is attached and electrically connected to the second printed circuit board 15. Otherwise, the camera module is similar to the examples described above.

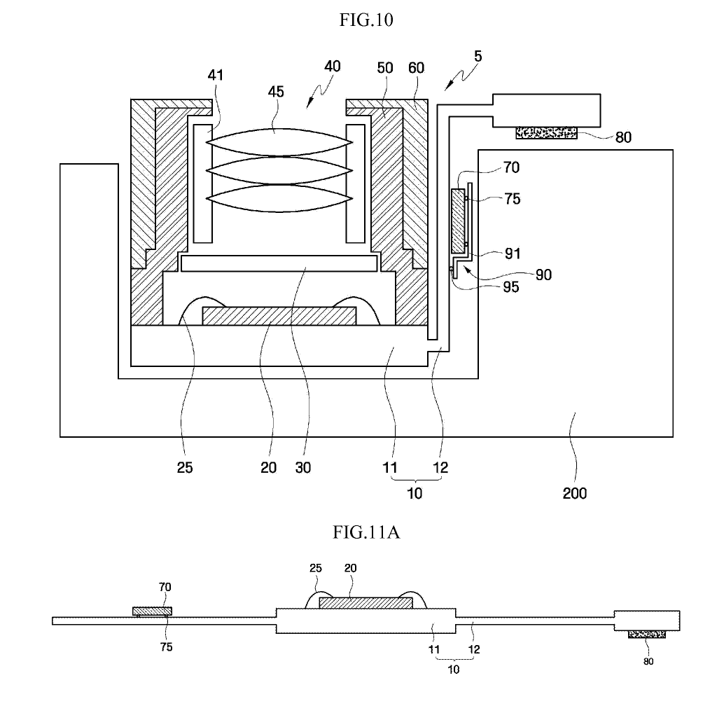

FIG. 10 shows a structure in which the camera module 5 is received in a case.

Referring to FIG. 10, the flexible region 12 of the rigid flexible printed circuit board 10 to which the film package 90 is attached is bent upward from the rigid region 11 beneath the housing 50 and then extends along the sidewall of the housing 50 and the metal cover 60. In this way, the film package 90 is disposed alongside a sidewall of the module constituted by the housing 50 and metal cover 60 as interposed between the sidewall and the case 200. This structure illustrates that ability of the camera module 5 to assume a small or compact state.

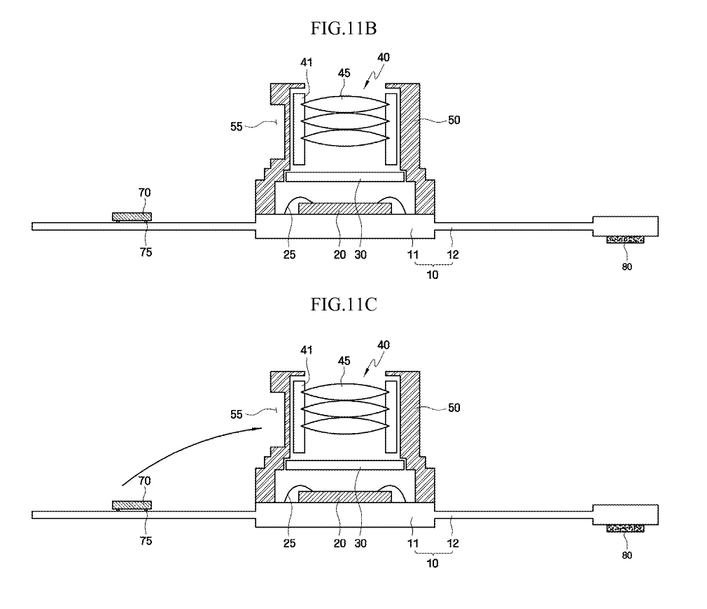

Next, an example of a method of manufacturing a camera module in accordance with the inventive concept will be described with reference to FIGS. 11A to 11C. The camera module 1 shown in and described with reference to FIG. 1 will be used as an example.

Referring to FIG. 11A, the first chip 20 is mounted to the rigid region 11 of the rigid flexible printed circuit board 10 using a through-silicon via or a wire bonding method. In the through-silicon via method, the chip is provided with vias extending through a silicon substrate of the chip, and contacts in the form of pads at a surface of the chip. The vias extend between and electrically connect the electrical components of the chip and the contacts. The contacts are set on and electrically connected to the wiring of the rigid flexible printed circuit board 10 so that the vias basically transmit the signals between the chip and the circuit board 10. In the wire bonding method, which is the method illustrated in the figure, the first chip 20 and the wiring of the circuit board 10 are connected by wires 25. The second chip 70 is mounted on the rigid flexible printed circuit board 10 by a flip-chip bonding method in which solder balls or metal bumps 75 or the like are used to connect contacts of the chip 70 to the wiring of the circuit board 10.

The connector 80 is also attached and electrically connected to the rigid flexible printed circuit board 10 by any suitable process.

Referring to FIG. 11B, the housing 50 is set on and secured to that part of the rigid region 11 of the rigid flexible printed circuit board 10 to which the first chip 20 has been mounted. At this time, the housing 50 contains the IR cut filter 30 and the lens unit 40.

Referring to FIG. 11C, that part of the flexible region 12 of the rigid flexible printed circuit board 10 to which the second chip 70 has been mounted is bent upward and the second chip 70 is placed in and hence, may be seated in the recess 55.

Referring back to FIG. 1, after the second chip 70 is placed in the recess 55, the metal cover 60 is secured to the housing 50 so as to cover the sidewall of the housing 50 in which the recess 55 is defined. At this time, that part of the flexible region 12 of the rigid flexible printed circuit board 10 to which the second chip 70 is mounted can be maintained against the sidewall of the housing 50 by the metal cover 60. That is, the metal cover 60 may be used to seat the second chip 70 in the recess.

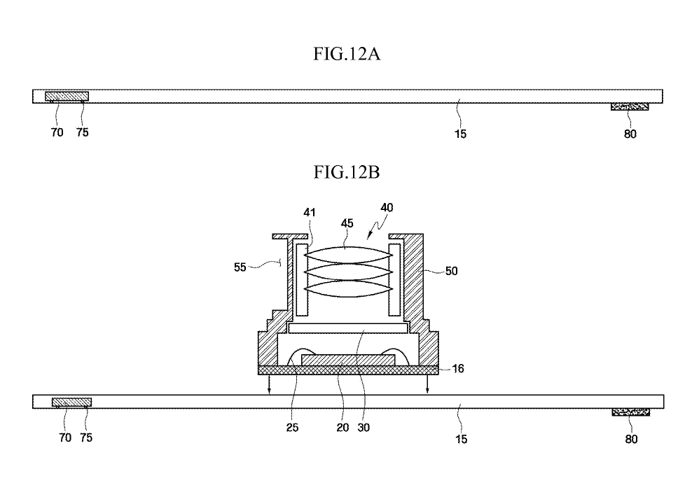

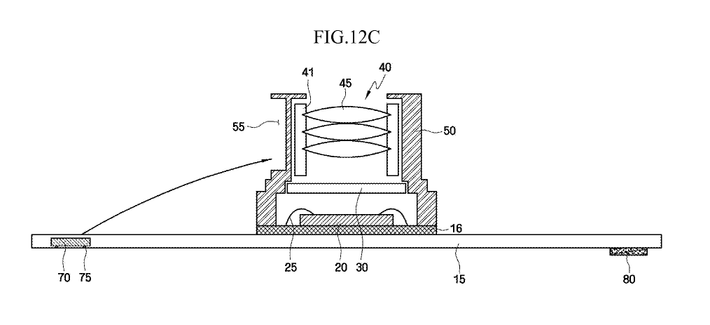

Next, another example of a method of manufacturing a camera module in accordance with the inventive concept will be described with reference to FIGS. 12A to 11C. The camera module shown in and described with reference to FIG. 3 will be used as an example.

Referring to FIG. 12A, the second chip 70 is embedded in the second printed circuit board 15. At this time, the second chip is electrically connected to wiring of the second printed circuit board 15, which wiring may be internal. Also, the connector 80 is attached and electrically connected to the second printed circuit board 15. The connector 80 may be mounted to the second printed circuit board 15 before or after the second chip 70 is embedded in the second printed circuit board 15.

Referring to FIG. 12B, the first printed circuit board 16 is attached and electrically connected to the second printed circuit board 15. Also, the first chip 20 is mounted and electrically connected to the first printed circuit board 16 before or after the first printed circuit board 16 is mounted to the second printed circuit board 15. The housing 50 is secured to the first printed circuit board 16 before or after the first printed circuit board 16 is mounted to the second printed circuit board 15. The housing 50 contains the IR cut filter 30 and the lens unit 40. Thus, IR cut filter 30 and the lens unit 40 are arranged above the first chip 20.

Referring to FIG. 12C, the second printed circuit board 15 is bent upward and the second chip 70 embedded in the second printed circuit board 15 is placed in the recess 55.

Referring to FIG. 3, after the second chip 70 embedded in the second printed circuit board 15 is placed in the recess 55, the metal cover 60 is placed over the sidewall of the housing 50 in which the recess is defined and is secured to the housing 50. The second printed circuit board 15 may thus be seated in the recess of the housing 50 using the metal cover 60.

Finally, embodiments of the inventive concept have been described above in detail. The inventive concept may, however, be embodied in many different forms and should not be construed as being limited to the embodiments described above. Rather, these embodiments were described so that this disclosure is thorough and complete, and fully conveys the inventive concept to those skilled in the art. Thus, the true spirit and scope of the inventive concept is not limited by the embodiments described above but by the following claims.

What is claimed is:

1. A camera module comprising:
a lens unit including a lens;
a first chip integral with the lens unit and having an image region disposed along an optical axis of the module such that light having passed through the lens unit is incident on the image region;
a housing extending around the lens unit and the first chip so as to enclose side surfaces of the lens unit and the first chip, the housing having a sidewall in which a recess is defined; and
a second chip seated in the recess.

2. The camera module of claim 1, wherein the first chip comprises a complementary metal oxide semiconductor (CMOS) image sensor or a charge coupled device (CCD) image sensor, and
the second chip comprises an image sensor processor, an autofocus actuator driver integrated circuit (IC), a passive device or a memory.

3. The camera module of claim 2, wherein the first chip has opposite first and second sides, the image region being located on the first side of the first chip, and further comprising a printed circuit board, the second side of the first chip facing the printed circuit board, and the housing being secured to the printed circuit board.

4. The camera module of claim 3, wherein the printed circuit board is a first printed circuit board having a relatively rigid section, and a relatively flexible section that is substantially more flexible than the rigid section, and
the first chip is connected to the first printed circuit board at the rigid section and the second chip is connected to the first printed circuit board at the flexible section.

5. The camera module of claim 3, wherein the printed circuit board is a first printed circuit board having a relatively rigid section, and a relatively flexible section that is substantially more flexible than the rigid section, and
further comprising a second printed circuit board to which the first chip is mounted, the second chip being connected to the first printed circuit board at the flexible section thereof.

6. The camera module of claim 3, further comprising an electrical connector attached to the printed circuit board.

7. A camera module comprising:
a lens unit including a lens;
a first chip integral with the lens unit and having an image region disposed along an optical axis of the module such that light having passed through the lens unit is incident on the image region;
a printed circuit board to which the first chip is mounted; and
a film package attached to the printed circuit board, the film package including a film having a circuit on a surface thereof, and a second chip mounted to the film.

8. The camera module of claim 7, wherein the first chip comprises a complementary metal oxide semiconductor (CMOS) image sensor or a charge coupled device (CCD) image sensor, and
the second chip comprises an image sensor processor, an autofocus actuator driver integrated circuit (IC), a passive device or a memory.

9. The camera module of claim 8, wherein an anisotropic conductive film attaches the film package to the printed circuit board.

10. The camera module of claim 8, wherein the printed circuit board has a relatively rigid section, and a relatively flexible section that is substantially more flexible than the rigid section.

11. The camera module of claim 10, wherein the first chip is connected to the printed circuit board at the rigid section thereof, and the film package is connected to the printed circuit board at the flexible section.

12. The camera module of claim 10, wherein the first and second chips are both connected to the printed circuit board at the rigid section thereof.

13. The camera module of claim 12, wherein the film package is disposed on one side of the printed circuit board and is connected to the printed circuit board at the rigid section thereof, and the film package is disposed on the other side of the printed circuit board and is connected to the printed circuit board also at the rigid section.

14. The camera module of claim 8, further comprising an electrical connector attached to the printed circuit board at the rigid section thereof.

15. The camera module of claim 14, wherein the film package and the electrical connector are juxtaposed on opposite sides of the rigid section of the printed circuit board from one another.

16. A camera module comprising:
a housing;
a lens unit disposed within the housing and including a lens;
a first chip disposed within the housing and integral with the lens unit, the first chip having an image region disposed along an optical axis of the module such that light having passed through the lens unit is incident on the image region;
a second chip; and
at least one printed circuit board, the first and second chips being mounted to and electrically connected to the at least one circuit board, the at least one printed circuit board comprising a first printed circuit board through which the first and second chips are physically connected and to which the housing is secured, and wherein at least a portion of the first circuit board is flexible, and at least part of the flexible portion is interposed between and physically separates the second chip from the first chip.

17. The camera module of claim 16, wherein the first chip comprises a complementary metal oxide semiconductor (CMOS) image sensor or a charge coupled device (CCD) image sensor, and
the second chip comprises an image sensor processor, an autofocus actuator driver integrated circuit (IC), a passive device or a memory.

18. The camera module of claim 16, wherein the at least one printed circuit board consists of the first printed circuit board, the first printed circuit board has a relatively rigid section, and a relatively flexible section that is substantially more flexible than the rigid section, the first chip is connected to the first printed circuit board at the rigid section thereof, and the relatively flexible section comprises the portion of the first circuit board that is interposed between and physically separates the second chip from the first chip.

19. The camera module of claim 16, wherein the at least one printed circuit board comprises a first printed circuit board on which the first chip is mounted, and a flexible printed circuit board to which the second chip is mounted, the housing being connected to the first printed circuit board at one side of the first printed circuit board, and the flexible printed circuit board being connected to the first printed circuit board at the other side of the first printed circuit board.

20. The camera module of claim 16, further comprising an electrical connector attached to the at least one printed circuit board and electrically connected through the at least one circuit board to the first and second chips.
